(19) United States
(12) Patent Application Publication
(10) Pub. No.: US 2007/0173415 A1
(43) Pub. Date: Jul. 26, 2007

(54) Stabilization of methyl butynol in hydrochloric acid systems

(75) Inventor: Malcolm Stuart Knopp, St. Albert (CA)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: BJ Services Company, Houston, TX (US)

(21) Appl. No.: 11/341,304

(22) Filed: Jan. 26, 2006

(51) Int. Cl. C09K 8/72

(52) U.S. Cl. 507/255; 507/266

(57) ABSTRACT

An acid treatment composition is provided including a corrosion inhibitor, an antisludge agent, an alpha olefin sulfonate, and an alkyl diphenyloxide sulfonic acid or derivative, in a hydrochloric acid solution. More specifically, the composition includes an acetylenic alcohol, an alkylaryl sulfonic acid, an alpha olefin sulfonate, and an alkyl diphenyloxide sulfonic acid or derivative, in a hydrochloric acid solution. A method for treating a hydrocarbon well with these acid stimulation compositions is also provided.

### BACKGROUND OF THE INVENTION

The present invention relates generally to the coupling of methyl butynol into various hydrochloric acid systems for use during acidizing treatment of crude hydrocarbon wells.

A common practice to increase production from a crude oil or gas well involves an acid stimulation treatment of the well. Acid stimulation of a well involves the pumping downhole of an aqueous acid solution which reacts with the subterranean hydrocarbon containing formations, such formations usually consisting of limestone or sand, to increase the size of the pores within the formations and provide enlarged passageways for the crude hydrocarbons to more freely move to collection points which otherwise would be obstructed.

A problem associated with the treatment of oil and gas wells with a hydrochloric acid solution is corrosion by the solution of metal surfaces of casing, tubing, and other equipment in the well bore. The expense of replacing or repairing damaged equipment is extremely high. Also, the corrosive action of the solution can substantially neutralize the solution before it enters the formation resulting in an undesirable introduction of metal ions into the formation. Corrosion by the acid solution is known to be exacerbated by high temperature and pressure conditions.

Various hydrochloric acid compositions that include corrosion inhibitors for diminishing the corrosive effects of the acid on metal surfaces have been developed and used previously. The types of components employed in corrosion inhibitors vary depending upon the nature of the compositions, the types of metal surfaces involved, associated environmental conditions, and so forth. For example, U.S. Pat. No. 5,697,443 relates to a method and composition for acidizing subterranean formations having a corrosion inhibitor that includes such compounds as a quartemary ammonium compound, an iodide salt, a formic acid, an acetylenic alcohol, and a surfactant.

Although acetylenic alcohols have been used as proven corrosion inhibitors in acid treatment solutions, it has been demonstrated that certain acetylenic alcohols “oil out” of hydrochloric acid solutions when heated to temperatures exceeding about 140° F. (60° C.), which is a typical downhole temperature condition. This oiling out of acetylenic alcohols is further accelerated by the inclusion of an alkyl aryl sulfonic acids, which are known antisludge agents used in acid treatment solutions. For example, it has been discovered that an acid solution including methyl butynol (an acetylenic alcohol) and dodecylbenzene sulfonic acid (an alkyl aryl sulfonic acid) at 0.7% and 1.0% (by volume) concentration, respectively, oiled out of 15% hydrochloric acid solution in just 12 minutes at 212° F. (100° C.). Under these conditions, the stimulation acid is considered unsuitable for use due to excessive corrosion of downhole metal equipment and the heterogeneous nature of the acid while pumping.

While in preparing these current acidizing treatments, the use of propargyl alcohol, a highly toxic material, leads to safety in handling and environmental issues. It is, therefore, a purpose of the present invention to provide new and useful compositions for inhibiting or preventing corrosion during the acid stimulation of hydrocarbon wells at relatively high downhole temperatures with a safer, less toxic, and more environmentally acceptable acid treatment fluid composition.

### SUMMARY OF THE INVENTION

An acid treatment composition is provided including a corrosion inhibitor, an antisludge agent, an alpha olefin sulfonate, and an alkyl diphenyloxide sulfonic acid or derivative, in a hydrochloric acid solution. More specifically, the composition includes an acetylenic alcohol such as methyl butynol, an alkylaryl sulfonic acid such as dodecylbenzene sulfonic acid, an alpha olefin sulfonate, and an alkyl diphenyloxide sulfonic acid or derivative such as a Dowfax-type chemical having n-hexyl as the alkyl chain, in a hydrochloric acid solution. It is preferred that the volume ratio of the alpha olefin sulfonate to alkylaryl sulfonic acid is less than 2.3:1.0. It is also preferred that the composition of the acetylenic alcohol in the hydrochloric acid solution is from about 0.1% to about 3.0% by volume, and that the composition of the alkyl diphenyloxide sulfonic acid in the hydrochloric acid solution is from about 0.4% to about 0.8% by volume

A method for treating a hydrocarbon well with these acid stimulation compositions is also provided. The method achieves acid stimulation while maintaining composition stability, thereby preventing the oiling out of the acetylenic alcohol after exposure to temperatures greater than 60° C. for about two hours.

### DETAILED DESCRIPTION OF PRESENT INVENTION

The compositions of the present invention provide a novel solution for effectively preventing corrosion during the acid stimulation of hydrocarbon wells at high downhole temperatures. The compositions of the present invention also provide a novel solution for effectively reducing the toxicity and environmental impact of many hydrochloric acid well stimulation treatment fluids.

The preferred corrosion inhibitor of the present invention includes an acetylenic alcohol having the general formula: 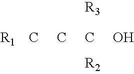
Wherein R₁, R₂ and R₃ are hydrogen, alkyl, phenyl, substituted phenyl or hydroxyl-alkyl radicals. In a preferred embodiment, R₁ comprises a hydrogen radical, R₂ comprises a hydrogen, methyl, ethyl or propyl radical, and R₃ comprises an alkyl radical having the general formula CₙH₂ₙ₊₁ where n is an integer from 1 to 10. Specific examples include methyl butynol, methyl pentynol, hexynol, ethyl octynol, propargyl alcohol, benzylbutynol, ethynycyclohexanol and the like. In the most preferred embodiment of the present invention, the acetylenic alcohol is methyl butynol. The acetylenic alcohol corrosion inhibitor is present in the acid solution in an amount effective to inhibit corrosion by the aqueous acid solution on the ferrous surfaces to be protected, preferably from about 0.1% to about 3.0% by volume.

By incorporating a surfactant into the above-described acetylenic alcohol/acid solution, it is possible to couple the acetylenic alcohol in the acid solution for extended intervals at temperatures exceeding 140° F. (60° C.). For gas wells (i.e. wells that produce gas without any oil), a preferred surfactant that proves useful for coupling acetylenic alcohol into 15% hydrochloric acid are ethoxylated alcohols such as Merpol® HCS (marketed by Stepan Company) and nonylphenol ethoxylates. The ethoxylated alcohol surfactant is included in the acetylenic alcohol/acid blend in a weight ratio as low as about 0.1:1.0 (surfactant:acetylenic alcohol), but preferably greater than a 0.2-0.3:1.0.

For oil wells (i.e. wells that produce oil as well as gas), a drawback to the use of the above mentioned surfactants is the formation of reaction side products causing precipitates when the acid package also includes anionic surfactants such as an alkylaryl sulfonic acid or sulfonate, and in particular, dodecylbenzene sulfonic acid (DDBSA), a well known antisludge agent. In this case, it is preferred that the acetylenic alcohol is coupled together in the acid with the alkylaryl sulfonic acid or sulfonate using the synergistic coupling affects of an alpha olefin sulfonate (AOS). The AOS is included in the alkylaryl sulfonic acid or sulfonate in a volume ratio as high as about 1.0:1.0 (AOS: alkylaryl sulfonic acid), but preferably no greater than about 2.3:1.0.

Although the AOS can supply adequate coupling when used alone, it is preferred to incorporate a co-surfactant that reverses the trend of the AOS to emulsify acid and crude oil mixtures. An alkyl diphenyl oxide sulfonic acid derivative is utilized as an effective co-surfactant with AOS. The preferred alkyl diphenyloxide sulfonic acid derivative is NE 207, a 1:1 methanol diluted or concentrated Dowfax™-type chemical based on n-hexyl as the alkyl chain. It has been discovered that such an alkyl diphenyloxide sulfonic acid derivative also further stabilizes the acid package while reversing the trend of the AOS to emulsify both live and spent acid and crude oil mixtures. The alkyl diphenyloxide sulfonic acid derivative is included in the compositions of the present invention in the general range between about 0.4 and about 3.0 percent by volume of the composition, and preferably between about 0.4 and about 0.8 percent by volume of the composition, however the optimal concentration ultimately depends upon the amount of AOS used in the acid package, as illustrated in the example below.

The following example is included to demonstrate the use of a preferred composition of the present invention. It should be appreciated by those of skill in the art that the techniques disclosed in the example which follows represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLE

Surfactant Package A was prepared as follows:

| | |
|---|---|
| DDBSA | 28 vol. % |
| AOS | 44 vol. % |
| Methanol | 28 vol. % |

Surfactant Package A was then blended at various concentrations (2%, 3%, and 4%) in 15% hydrochloric acid with 0.7% methyl butynol (MB) and selected concentrations of NE207, and tested at 100° C. to determine acid blend stability (i.e. minutes before oiling out).

| | | | Acid Package Stability |
|---|---|---|---|
| % A | % MB | % NE207 | (minutes before oiling out) |
| 2.0 | 0.7 | 0.0 | 24 minutes (not suitable) |
| 2.0 | 0.7 | 0.2 | 65 minutes (not suitable) |
| 2.0 | 0.7 | 0.4 | No oiling out after 120 minutes (suitable) |
| 2.0 | 0.7 | 0.6 | No oiling out after 120 minutes (suitable) |
| 2.0 | 0.7 | 0.8 | No oiling out after 120 minutes (suitable) |
| 3.0 | 0.7 | 0.0 | 28 minutes (not suitable) |
| 3.0 | 0.7 | 0.2 | 40 minutes (not suitable) |
| 3.0 | 0.7 | 0.4 | 60 minutes (not suitable) |
| 3.0 | 0.7 | 0.6 | No oiling out after 120 minutes (suitable) |
| 3.0 | 0.7 | 0.8 | No oiling out after 205 minutes (suitable) |
| 4.0 | 0.7 | 0.6 | 90 minutes (suitable) |
| 4.0 | 0.7 | 0.8 | 175 minutes (suitable) |
| 4.0 | 0.7 | 1.0 | 241 minutes (suitable) |

As demonstrated, the inclusion of NE207 effectively prevents oiling out in acid blends containing the acid corrosion inhibitor methyl butynol.

The inclusion of iron control products commonly used during oilwell stimulation was also tested with the above blends to determine the effect on the stabilization of the acid package. Tests were preformed using iron control agents Nowferr 1 (hypophosphite), Nowferr 14P (copper sulphate catalyst), and Nowferr 12 (potassium iodide solution) with ferric iron solution as shown below, resulting in further stabilization and coupling to the acid blend:

| | % | % | % | Acid Package |
|---|---|---|---|---|
| Acid Blend | Nowferr 1 | Nowferr14P | Nowferr 12 | Stability |
| 3.0% A | 2.1 | 0.0125 | 0.35 | No oiling out |
| 0.7% MB | | | | after 240 |
| 0.8% NE207 | | | | minutes |
| 4.0% A | 2.1 | 0.0125 | 0.35 | No oiling out |
| 0.7% MB | | | | after 240 |
| 1.0% NE207 | | | | minutes |

Note that one of ordinary skill in the art will appreciate that different reservoirs react differently to acids and their additives. What is disclosed herein is a versatile acid stimulation package based upon the use of methyl butynol as the acid corrosion inhibitor, and made viable by stabilizing the package by varying the ratios of the coupled acid surfactant package with an alkyl diphenyl oxide sulfonic acid derivative such as NE207.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the methods described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the scope and concept of the invention.

What is claimed is:

1. A composition for use in the acid treatment of hydrocarbon wells, comprising:
a corrosion inhibitor;
an antisludge agent;
an alpha olefin sulfonate; and
an alkyl diphenyloxide sulfonic acid or derivative;
in a hydrochloric acid solution.

2. A composition for use in the acid treatment of hydrocarbon wells, comprising:
an acetylenic alcohol;
an alkylaryl sulfonic acid; and
an alpha olefin sulfonate;
in a hydrochloric acid solution.

3. The composition of claim 2, further comprising an alkyl diphenyloxide sulfonic acid or derivative.

4. The composition of claim 2, wherein the acetylenic alcohol has the general formula: 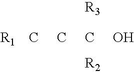
wherein R₁, R₂ and R₃ are selected from the group consisting of hydrogen, alkyl, phenyl, substituted phenyl and hydroxyl-alkyl radicals.

5. The composition of claim 4, wherein R₁ comprises a hydrogen radical, R₂ comprises a hydrogen, methyl, ethyl or propyl radical, and R₃ comprises an alkyl radical having the general formula CₙH₂ₙ₊₁ where n is an integer from 1 to 10.

6. The composition of claim 2, wherein the acetylenic alcohol is methyl butynol.

7. The composition of claim 2, wherein the alkylaryl sulfonic acid is dodecylbenzene sulfonic acid.

8. The composition of claim 2, wherein the alkyl diphenyl oxide sulfonic acid is a Dowfax-type chemical having n-hexyl as the alkyl chain.

9. The composition of claim 2, wherein the volume ratio of alpha olefin sulfonate to alkylaryl sulfonic acid is less than about 2.3:1.0.

10. The composition of claim 2, wherein the composition of the acetylenic alcohol in the hydrochloric acid solution is from about 0.1% to about 3.0% by volume.

11. The composition of claim 2, wherein the composition of the alkyl diphenyloxide sulfonic acid in the hydrochloric acid solution is from about 0.4% to about 3.0% by volume.

12. The composition of claim 2, wherein the composition of the alkyl diphenyloxide sulfonic acid in the hydrochloric acid solution is from about 0.4% to about 0.8% by volume.

13. A method for treating a hydrocarbon well with a hydrochloric acid solution, comprising:
preparing a hydrochloric acid solution comprising an acetylenic alcohol, an alkylaryl sulfonic acid, an alpha olefin sulfonate, and an alkyl diphenyloxide sulfonic acid or derivative; and
treating a hydrocarbon well with the hydrochloric acid solution.

14. The method of claim 13, wherein the acetylenic alcohol does not oil out of the solution after exposure to temperatures greater than about 60° C. for about two hours.

15. The method of claim 13, wherein the acetylenic alcohol has the general formula: 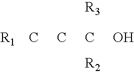
wherein R₁, R₂ and R₃ are selected from the group consisting of hydrogen, alkyl, phenyl, substituted phenyl and hydroxyl-alkyl radicals.

16. The method of claim 15, wherein R₁ comprises a hydrogen radical, R₂ comprises a hydrogen, methyl, ethyl or propyl radical, and R₃ comprises an alkyl radical having the general formula CₙH₂ₙ₊₁ where n is an integer from 1 to 10.

17. The method of claim 13, wherein the acetylenic alcohol is methyl butynol.

18. The method of claim 13, wherein the alkylaryl sulfonic acid is dodecylbenzene sulfonic acid.

19. The method of claim 13, wherein the alkyl diphenyl oxide sulfonic acid is a Dowfax-type chemical having n-hexyl as the alkyl chain.

20. The method of claim 13, wherein the volume ratio of alpha olefin sulfonate to alkylaryl sulfonic acid is less than about 2.3:1.0.

21. The method of claim 13, wherein the composition of the acetylenic alcohol in the hydrochloric acid solution is from about 0.1% to about 3.0% by volume.

22. The method of claim 13, wherein the composition of the alkyl diphenyloxide sulfonic acid in the hydrochloric acid solution is from about 0.4% to about 3.0% by volume.

23. The method of claim 13, wherein the composition of the alkyl diphenyloxide sulfonic acid in the hydrochloric acid solution is from about 0.4% to about 0.8% by volume.
